(19) United States
(12) Patent Application Publication
(10) Pub. No.: US 2010/0007293 A1
(43) Pub. Date: Jan. 14, 2010

(54) PROGRAMMABLE POWER-CONTROL CIRCUIT AND METHODS OF OPERATION

(76) Inventors: Ives Burr Meadors, (US); David Wayne Boyd, (US)

Correspondence Address: David Boyd, 2351 NW York St., Portland, OR, 97210, US

(21) Appl. No.: 12/499,055

(22) Filed: Jul. 7, 2009

Related U.S. Application Data
(60) Provisional application No. 61/079,433, filed on Jul. 9, 2008.

(51) Int. Cl. H02P 27/00; H02J 7/10; G05F 1/618

(52) U.S. Cl. 318/139; 320/140; 323/282

(57) ABSTRACT

An electric-motor controller uses multiple semiconductor switches in parallel, arranged so as to improve turn-on and turn-off synchronization. A physical “sandwich” arrangement improves manufacturability of some embodiments. A system using the controller can recharge a battery pack from a charging source of a different voltage by using a field coil of the motor as an inductor in a step-up or step-down circuit. Controller software monitors parameters such as battery voltage, temperature and current to adjust system operation.

### PRIORITY CLAIM

This application claims the benefit of U.S. Provisional Application No. 61/079,433, filed Jul. 9, 2008.

### FIELD

The invention relates to controlling electric power in systems comprising at least two of a rechargeable battery, an electric motor, and a power controller. More specifically, the invention relates to circuits, systems and methods of operating motor controllers, motors and rechargeable battery arrays.

### BACKGROUND

Electric motors come in a wide variety of shapes and sizes, and produce a similarly wide range of electromotive forces, speeds, directions and distances. For example, piezoelectric motors may exert piconewtons of force over distances of only a few angstroms, while a large linear traction motor may be capable of levitating and accelerating a monorail with a mass of hundreds of tons. However, almost all electric motors require some means to control the electric power applied to them.

Control of electric motors has advanced from basic on/off switches to interrupt the flow of current to more complex systems incorporating feedback loops and microprocessors to tailor the power delivery in response to changing conditions and operator requirements. Some motor controllers even present a rudimentary configuration or programming interface so that certain parameters (e.g., battery operational voltage range, motor current limit) can be set. However, disparate systems' configuration and control capabilities have developed in an ad hoc manner, leading to multiple incompatible implementations of some features, while other challenges go unaddressed.

One emerging application where electric motor control shortcomings are increasingly becoming apparent is electric vehicles. Of course, electric motors have been used for years in niche vehicle applications such as fork lifts and golf carts, but development of practical road-going vehicles is hindered by the difficulty of precisely controlling the high voltages and large currents necessary to obtain adequate performance. (Electric vehicle development is also restrained by battery technology limitations and inadequate charging infrastructure.) Circuits, apparatus, systems and methods to improve motor controllers and battery chargers may be of significant value in developing roadworthy electric vehicles.

### SUMMARY

One embodiment of the invention is an electric motor controller with improved power-handling capabilities.

One embodiment of the invention is an electric motor controller physical configuration that is easier to manufacture.

One embodiment of the invention is an electric motor controller that doubles as a battery charger.

One embodiment of the invention is an apparatus to permit a prior-art motor controller to be used as a battery charger.

One embodiment of the invention is a motor controller with automatic configuration capabilities.

One embodiment of the invention is a motor controller safety circuit to protect system components from overload damage.

One embodiment of the invention is a battery management system that simplifies electric vehicle maintenance.

Other embodiments of the invention are described below, and their novel characteristics are particularly identified in the attached claims.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is an exploded perspective view of a motor controller implementing a number of embodiments of the invention.

FIG. 2 is a block diagram illustrating basic principles of direct current (“DC”) motor control.

FIG. 3 shows a simplified motor controller using parallel semiconductor switches.

FIG. 4 is a representative circuit showing many of the features of a practical motor controller according to an embodiment of the invention.

FIGS. 5A and 5B show the front and back sides of a printed circuit board to illustrate certain physical layout features of an embodiment of the invention.

FIG. 6 is a hybrid physical and circuit diagram showing features of an embodiment of the invention.

FIGS. 7A, 7B and 7C show various prior-art battery charging circuits.

FIGS. 8A and 8B show battery charger circuits according to embodiments of the invention.

FIG. 9 is a block diagram of a system implementing an embodiment of the invention.

FIG. 10 shows an electrical current sensor according to an embodiment of the invention.

FIG. 11 is a flow chart outlining a method according to an embodiment of the invention.

FIG. 12 is an image of an actual circuit board layout for an embodiment of the invention.

### DETAILED DESCRIPTION

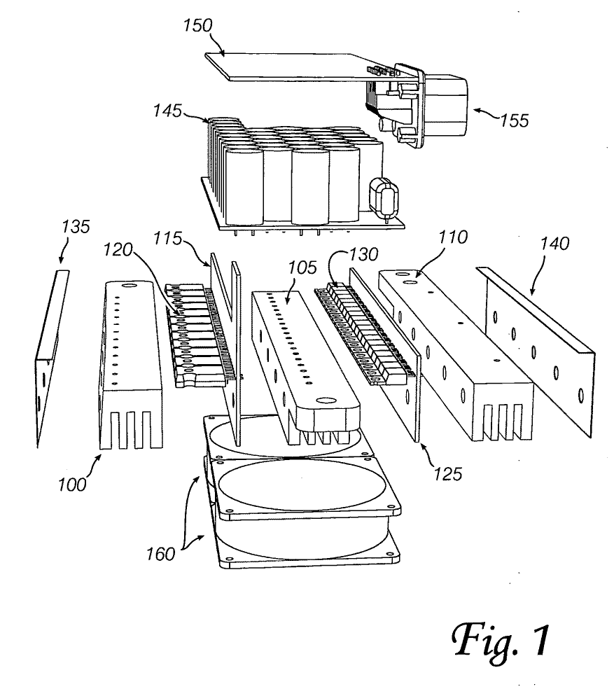

FIG. 1 is an exploded view of a motor controller according to an embodiment of the invention. A number of novel features are visible in this view, but a brief review of electric motor control technology, and discussion of individual features, may permit better understanding of the present invention. Discussion of this complete system will be deferred until later.

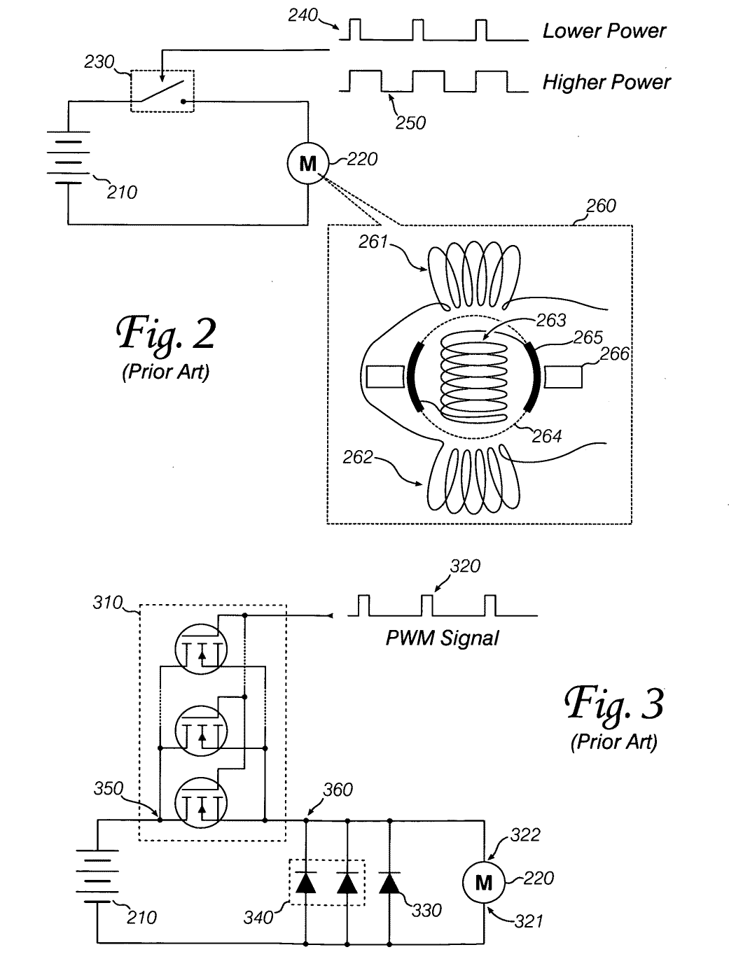

Accordingly, FIG. 2 shows a typical battery/controller/motor circuit. Battery 210 supplies electrical current to operate direct-current (“DC”) motor 220 when controller 230 (represented here as a simple switch) is in its “closed” position. When the switch is closed, the motor turns; and when the switch is open, the motor coasts.

If switch 230 is closed and opened rapidly, motor 220 will run and then coast, run and then coast; with a net power delivery proportional to the percentage of time switch 230 is closed. If the opening and closing occurs at a high enough frequency, the inertia of the motor and any connected mechanical system will dampen the “run” impulses to produce an apparently smooth range of power delivery. For example, a first control signal 240 may produce a lower power, while a second control signal 250 may produce higher power.

It is, of course, possible to control the power of a DC motor by placing a variable resistance in series with the motor, but this is extremely inefficient, as any power delivered by the battery but not used by the motor is dissipated as heat by the variable resistance. Most practical, large-scale motor systems use pulse-width modulation (“PWM”), as described in reference to FIG. 2, rather than a variable resistance.

It should be appreciated that a DC motor comprises a number of elements, some of which are shown in inset 260. Field coils 261, 262 create a stationary magnetic field when energized, while current in armature coil 263 flows first in one direction and then in the other as armature 264 rotates and commutators 265 change positions relative to stationary brushes 266. The field coils 261, 262 and the armature coil 263 may be connected electrically in series or in parallel to form series- or shunt-wound motors, respectively. Other arrangements of coils, and components such as permanent magnets, can form different types of DC motors, which may also be controlled by the PWM method outlined above. It is important to recognize that starting and stopping motor currents, which may be on the order of tens, hundreds, or even thousands of amperes; quickly enough so that the mechanical inertia of the system can dampen the force impulses, without damaging the switching circuitry, is not a trivial undertaking.

Ordinary mechanical switches cannot be used to perform PWM at the frequencies and load currents required for control of motors in electric vehicles: at switching frequencies around 20-50 kHz, even a switch capable of millions mechanical cycles would likely fail within minutes, and contact arcing would destroy the switch quickly in any case. Practical motor controllers use semiconductor devices such as bipolar transistors, metal-oxide semiconductor field-effect transistors (“MOSFETs”), insulated-gate bipolar transistors (“IGBTs”) and the like to switch the motor currents. These semiconductor devices accept a control signal in the form of a relatively small voltage or current, and switch a large load current accordingly. Since they have no moving parts and no air gap to support an arc, they often have a very long expected service life, provided that their maximum voltage, current and junction temperature ratings are not exceeded. (If ratings are exceeded, they may fail spectacularly, in either open-circuit or short-circuit modes.)

Individual semiconductor devices with breakdown voltage ratings up to several hundred or a few thousand volts, and continuous current ratings of tens or low hundreds of amperes are available, but these devices tend to be quite expensive. An economically favorable arrangement involves the use of several devices with smaller current ratings operating in parallel to switch the full load current. FIG. 3 is a simplified circuit diagram showing such an arrangement.

In FIG. 3, an array of semiconductor switches 310 controls the flow of current from battery 210 through motor 220 according to PWM signal 320. Semiconductor switches 310 perform the function of switch 230 in FIG. 2. N-channel enhancement-mode MOSFETs are shown here, but straightforward modifications to this circuit, within the capabilities of one of ordinary skill in the art, permit the use other types of MOSFETs, bipolar transistors, or IGBTs. Diode 330 (or an array of diodes 340) permits current to flow from motor terminal 321 to motor terminal 322 when semiconductor switches 310 are turned off. Otherwise, the inductive character of motor 220 might cause the voltage differential between circuit nodes 350 and 360 to exceed the breakdown voltage of the semiconductor switches.

The relatively simple circuit shown in FIG. 3 does not identify or represent several important characteristics of the circuit when it is operated at practical switching frequencies and power levels (for example, 25 kHz switching, 192 volts and 300 amperes). Under these conditions, even slight variations between turn-on and turn-off times of the individual semiconductor switches can cause a switch to carry a disproportionate share of the load, resulting in its premature failure. Failure of one switch forces the other switches to carry a greater share of the load, which often results in a cascade of failures.

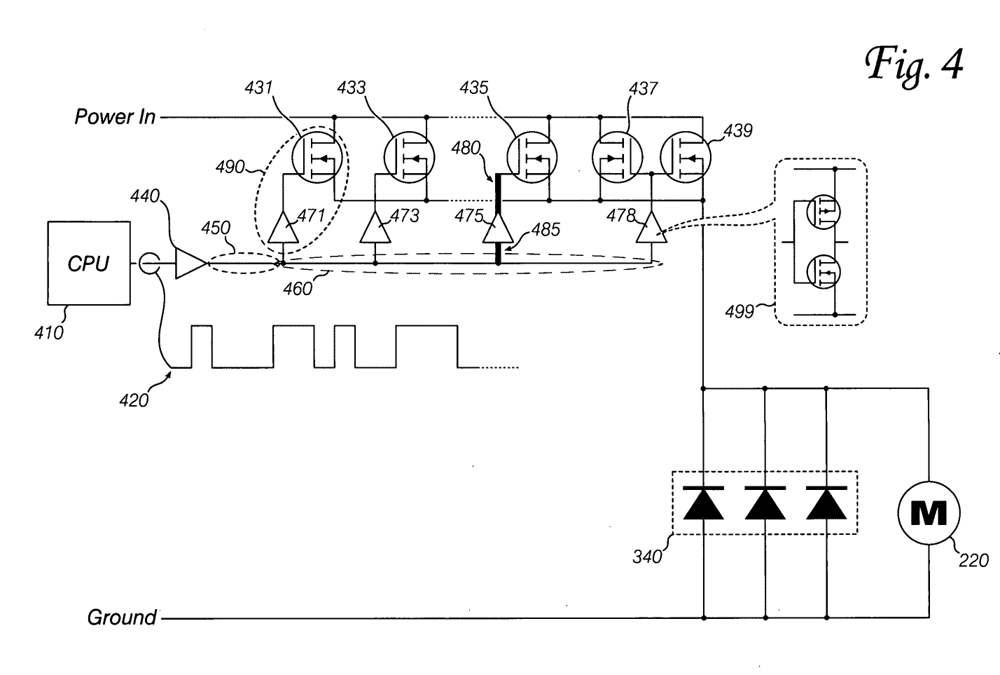

FIG. 4 shows a portion of the basic circuit of FIG. 3 with modifications according to an embodiment of the invention to improve its operation under real-world conditions. A programmable processor 410 (“central processing unit” or “CPU”) produces a signal 420 to control an array of semiconductor switches 431, 433, 435, 437, 439. This signal may be buffered by a driver 440 before being coupled onto an electrical conductor for distribution to the switches.

In this circuit diagram, conductor 450, circuit node 460 and the inputs to local buffers 471, 473, 475, 478 are all theoretically at the same electrical potential, but in a physical circuit, each conductor will have a length and width, and consequently corresponding parasitic capacitances and inductances, that have a significant effect on the circuit's operation. These parasitic effects will be discussed in greater detail below.

In the circuit of FIG. 4, each semiconductor switch is associated with a local buffer or “gate driver” (e.g., buffer 471 for switch 431 and buffer 478 for switches 437 and 439). The local buffer for a switch is located as near its switch or switches as practicable, so that the switch driver signal from a local buffer is communicated to the corresponding switch via an electrical connection with smaller parasitic capacitance and inductance, and consequently with less distortion. In other words, the conductor shown in bold at 480 should be as short as possible. The local gate drivers may be, for example, push-pull drivers (see inset 499, in which some passive components such as resistors and capacitors have been omitted for clarity). The local buffers may have a higher input impedance than the semiconductor switch control input itself. The input signal to each local buffer (i.e., the electrical connection between node 460 and a buffer, one of which is identified in bold at element 485) is preferably carried by a conductor that is very similar in length and arrangement to the conductors carrying such signals to neighboring buffers. This helps match the buffer input impedances and reduces control signal distortion (which, in turn, reduces differences between turn-on, turn-off and operating characteristics of the plurality of semiconductor switches). Although local gate drivers controlling different numbers of semiconductor switches are shown in FIG. 4, in most embodiments, each local gate driver will control the same number of switches as every other gate driver.

Note that the control circuitry described with reference to FIG. 4 (i.e., local gate drivers 471, 473, 475, 478) is relatively low power: the currents flowing through the conductors comprising node 460 are small, and even the current flowing from a local buffer to its controlled switch is not great. Therefore, the components used in this portion of the motor controller may be low-power, surface-mount devices (“SMD”). The small physical size of such devices permits them to be located very close to the semiconductor switches they control, which, as noted previously, provides favorable operational characteristics.

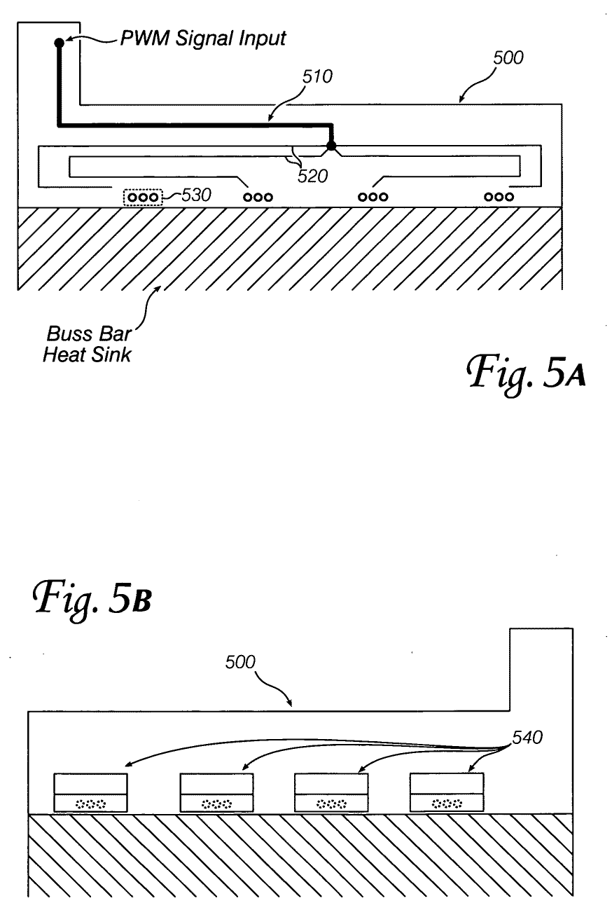

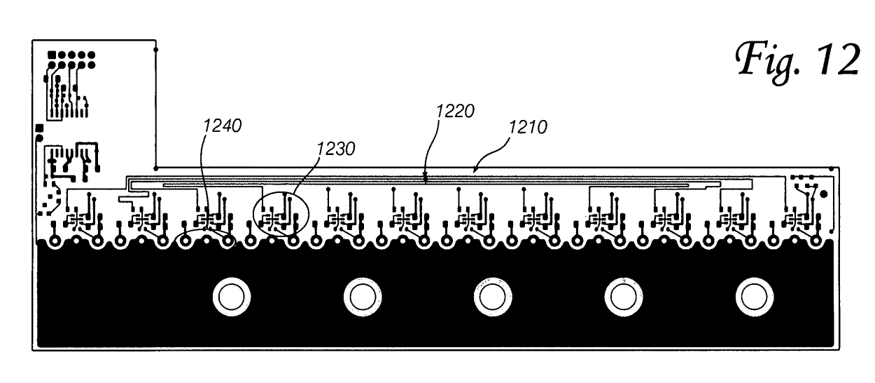

FIGS. 5A and 5B shows a detail of the physical circuit layout visible in FIG. 12 at 1210. In FIG. 5A, an electrical conductor 510 formed on printed circuit board 500 corresponds to the portion of the PWM distribution network identified at 450 in FIG. 4. Smaller conductors 520 (corresponding to connections 480) carry this signal to local gate driver circuits 532, 534, 536, 538 implemented using SMD parts placed near the leads of through-hole semiconductor switches located on the opposite side of PCB 500. Each of these smaller conductors is arranged in a serpentine fashion to have an approximately equal length, although the Cartesian distances from the end of conductor 510 to each local gate driver circuit vary significantly. The serpentine arrangement causes each gate driver input circuit to have approximately equal inductance and capacitance characteristics.

FIG. 5B shows the reverse side of PCB 500, where semiconductor switches 542, 544, 546 and 548 are shown attached to a conductive buss bar that also functions as a heat sink. The PWM control distribution circuit layout shown in FIG. 5A has been examined carefully, and it has been determined that the parasitic inductance and capacitance of the first common portion of the input circuit (conductor 510) act to filter some higher-frequency components from the PWM signal, resulting in somewhat longer rise and fall times. Ordinarily, extended switching times cause inefficiency and increased thermal losses, but in this case, it appears that the additional parasitic capacitance and inductance of the serpentine segments do not further degrade the PWM signal significantly, so each local gate driver circuit receives a very similar control signal and can therefore apply the same signal to its semiconductor switch. The improvement in gate control signal alignment has been found to be more beneficial than the increased losses due to slower switching.

By matching the control signals applied to the switches as closely as possible, sensitivity of the circuit to variations between the semiconductor switches themselves is reduced, so it is less important to select well-matched components for the switches. Reducing or removing the burden of matching components may reduce manufacturing costs.

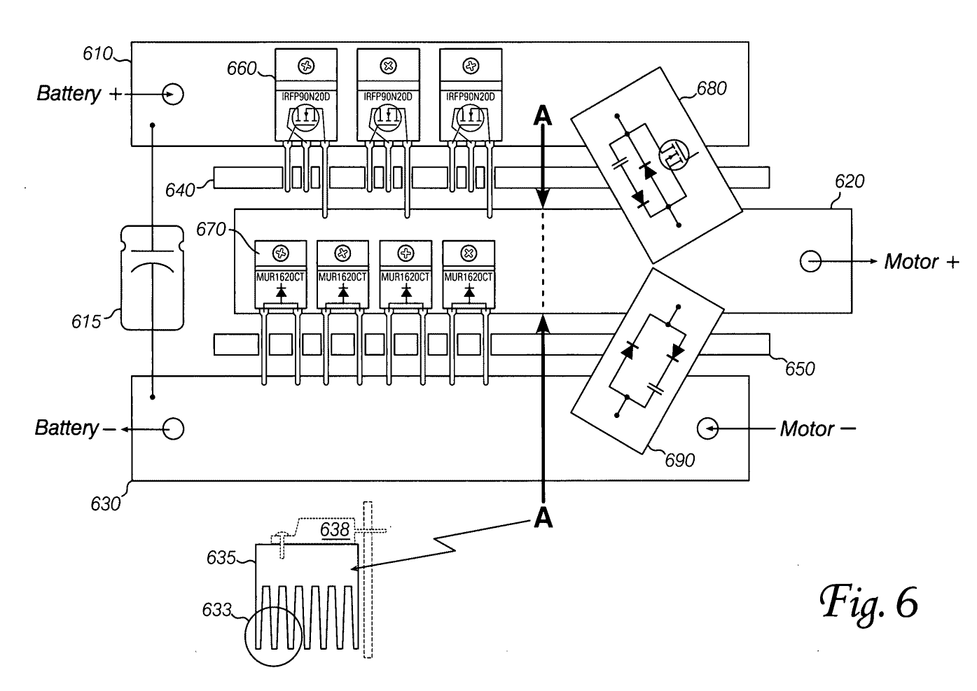

FIG. 6 shows a hybrid circuit diagram and physical circuit layout to illustrate some additional advantages of the motor controller arrangement shown in FIG. 1. Physically, the structure includes three electrically conductive buss bars 610, 620 and 630, which carry current from a power supply such as a battery to and from a load such as a motor. The buss bars are separated by printed circuit boards (“PCBs”) 640 and 650, and are therefore electrically isolated except for circuit elements such as semiconductor switches 660 and diodes 670, which control the flow of current between the buss bars. The principal power-controlling semiconductors, MOSFETs 660 and diodes 670, are shown physically as they may be attached to the buss bars, while circuit diagrams 680 and 690 show the power-controlling semiconductors and their associated support components. For example, circuit diagram 680 shows the power MOSFET, its intrinsic “freewheeling” diode, and a second diode in series with a capacitor. These latter two components, which form a diode “snubber,” need only handle limited power, so they may be small, surface-mount devices placed on the upper or lower surfaces of PCB 640, near their associated MOSFET. Similarly, in circuit diagram 690, the main power-handling diode is shown disposed in anti-parallel with another series diode-capacitor snubber. The snubber components may also be small SMD devices. A bank of capacitors is attached between buss bar 610 and buss bar 620. This is represented in FIG. 6 as a large schematic capacitor 615, but the entire capacitor bank and its spatial relationship to the buss bars can be seen in FIG. 1.

Power-controlling semiconductor switches 660 and diodes 670 may be mounted directly to their adjacent buss bars. In the configuration depicted, the semiconductors may be in both electrical and thermal contact with the buss bars. Since good electrical conductors such as copper and aluminum are often also good thermal conductors, mounting the semiconductors as shown helps maintain thermal equilibrium among the junction temperatures of the semiconductors. This helps ensure that each semiconductor device carries its share of the load, but no more and no less. The buss bars may be formed with surface-area-increasing features such as fins 633, as shown in the cross-section at A-A, element 635. These features permit the buss bar to perform double duty, as both an electrical conductor and a heat sink for an attached semiconductor device 638.

The buss-PCB-buss sandwich structure shown in FIG. 6 has several favorable characteristics: local gate driver circuits can be placed very close to their corresponding gates; power semiconductors can be attached in both thermal and electrical contact with the buss bars; and the layered structure is easy to manufacture. The capacitor bank can be placed across the outside buss bars, and conductive foil can be used to create a tunnel or duct along the length of the buss bars through which fans can draw air to cool the power semiconductor devices. (This duct is easier to see in the exploded view of FIG. 1.) The entire apparatus may be enclosed in an electrically-isolated housing with a power input, a power output, and a low-voltage command/monitoring interface, the apparatus resembling both physically and operationally the controlled switch 230 shown in FIG. 2.

Referring now to the exploded view of FIG. 1, the three conductive buss bars 100, 105 and 110 are shown, separated by PCB 115 carrying semiconductor switches 120, and PCB 125 carrying semiconductor diodes 130. At either side, a conductive foil sheet 135, 140 connects the outside buss bars 100, 110 to the positive and negative terminals of a bank of electrolytic capacitors 145. An interface module 150 receives control signals provided through connector 155 and may return status information to an external computer. Below the buss bars, fans 160 force air into an enclosure (not shown) to cool the semiconductor switches and other components.

With the foregoing power control circuit and structure in mind, we consider a second challenge faced by developers of road-going electric vehicles: that of charging batteries. Electric vehicles are typically powered by banks of batteries containing many cells in series. The voltage of a battery pack depends on the number of cells in it and their connection topology (series or parallel), but pack voltages between about 48V and 360V are common. A battery charger forces current into the battery pack “backwards,” causing a chemical reaction to proceed in the reverse direction from the battery's normal current-supplying mode. For example, in a lead-acid battery, the battery normally supplies current at about 2 volts per cell as a result of the following chemical reactions:

Pb(s)+H₂SO₄(aq)+H₂O(l)→PbSO₄(s)+H₃O⁺(aq)+2e⁻ ε⁰=0.356V

### (Oxidation at the Battery's Anode)

PbO₂(s)+3H₃O⁺(aq)+HSO₄⁻(aq)+2e⁻→PbSO₄(s)+5H₂O(l) ε⁰=1.685V

### (Reduction at the Battery's Cathode)

Thus, each cell of a lead-acid battery develops a potential difference of approximately 2.041V. Batteries commonly contain three or six cells, giving a voltage around 6 or 12 volts, respectively.

Charging drives these reactions backwards, restoring the original chemical balance so that the battery can provide current to a load again. Various types of batteries use different chemistries, but the basic principles are the same: a chemical reaction occurs during normal use, permitting the battery to supply current to a load; and the chemical reaction is reversed by charging to restore the battery's chemical composition and enable it to provide current again.

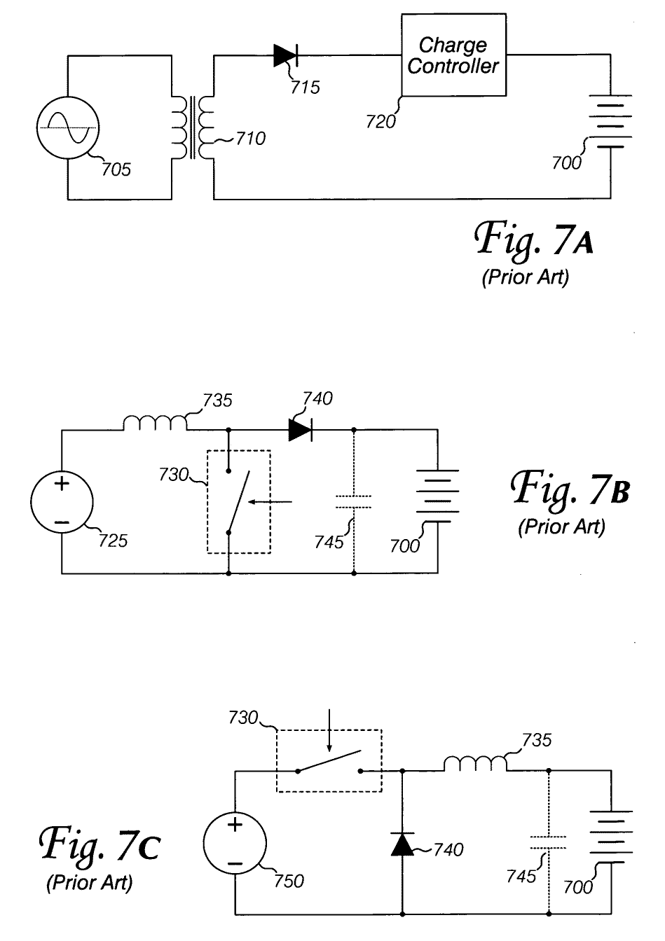

Because battery packs have varying total voltages, and because different battery chemistries have different preferred charging profiles (with respect to maximum current, duration, temperature, and so on), charging systems are typically specialized for a particular application. In particular, a charger is typically designed to convert public-utility-provided alternating current at a common voltage such as 120V or 240V to direct current at the appropriate voltage, and then to control the flow of current into the battery pack. FIG. 7A shows a typical prior-art charger. To charge battery 700, the voltage of alternating-current (“AC”) source 705 is adjusted by transformer 710, and the adjusted AC voltage is converted to direct current (“DC”) by rectifier 715 before being conducted to battery 700 by charge controller 720. The charge controller may adjust the charging rate to achieve a faster charge, longer battery life, or some other objective.

A battery pack can also be charged from a DC source, even if the source is at a different voltage from the pack. For example, FIG. 7B shows how battery 700 can be charged from a DC source 725 at a voltage lower than the pack. Switch 735 (which is actually a semiconductor switch, for the reasons discussed above) closes to allow current to flow through inductor 735. This causes a magnetic field to develop. When switch 730 opens, the magnetic field collapses and current is forced through diode 740 and into battery 700, even though the battery voltage is higher than the DC source voltage. (A capacitor 745 may be added to help smooth the spikes from the inductor.) The circuit shown in FIG. 7B is commonly called a “boost” or “flyback” converter. It can be quite efficient, particularly when the step-up ratio is in the range of about 1.5 to about 5. Furthermore, many factors that affect the efficiency of a flyback converter are the same as the factors that affect the efficiency of a pulse-width modulated motor controller. Thus, an efficient PWM controller according to an embodiment of the invention can also serve as an efficient flyback converter switch.

FIG. 7C shows how a battery pack 700 can be charged from a DC source 750 whose voltage exceeds that of the battery. This circuit uses the same components as the circuit of FIG. 7B, but arranged differently. In operation, switch 730 is closed to allow current to flow from source 750, through inductor 735 and into battery 700. However, before the voltage across battery 700 rises excessively (which could damage the battery), switch 730 is opened. Then, as the magnetic field of inductor 735 collapses, additional current is drawn through diode 740 and pumped into the battery. This circuit arrangement is commonly called a “buck” or “step down” converter.

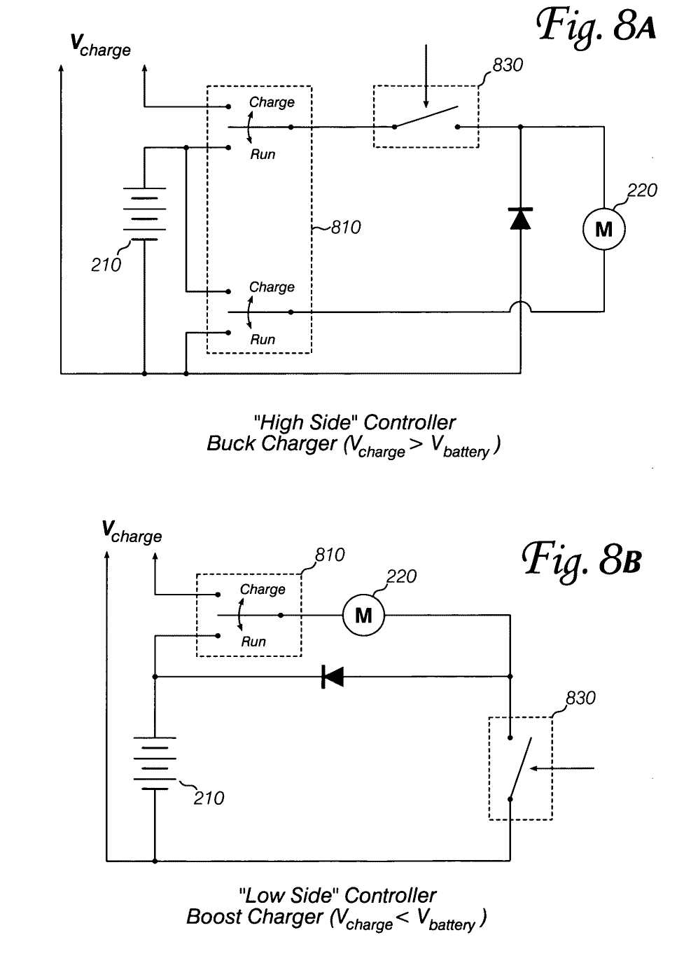

An electric motor contains a number of coils, which can be thought of as inductors, and used as such in some circuits. (Both direct current, “DC,” and alternating current, “AC,” motors have such coils, so both types of motor can be used in the configuration described here.) Furthermore, note that the boost and buck circuits shown in FIGS. 7B and 7C are somewhat similar in arrangement to the battery/controller/motor circuit shown, for example, in FIG. 2. The inventors have determined that, with minor circuit reconfigurations that can be accomplished by relatively lightly-stressed switches or contactors, a motor controller can be used as part of an electric vehicle's battery charging system. The field coils in the motor can be used as ordinary inductors in a buck or boost circuit configuration, permitting the batteries to be charged from a DC source of arbitrary voltage. Thus, with little additional hardware (chiefly, a few circuit reconfiguration switches) a motor controller according to an embodiment of the invention can be used to charge the batteries, as well as to operate the motor. FIG. 8A shows how a “high side” motor controller circuit can be reconfigured as a buck converter to charge the battery from a source at a higher voltage than the battery pack. FIG. 8B shows how a “low side” motor controller circuit can be reconfigured as a boost converter to charge the battery from a source at a lower voltage than the battery pack. Reconfiguration switch 810 changes the circuit between the normal “Run” mode and the buck- or boost-charging “Charge” mode. (“High side” and “low side” refer to the relationship between the battery, motor controller switch and motor: in a high side arrangement, the switch is between the battery's positive terminal and the motor; while in a low side arrangement, the switch is between the battery's negative terminal and the motor. Both arrangements have advantages and disadvantages, so both are encountered in electric vehicles.)

Since the charging circuits of FIGS. 8A and 8B pass current through the motor (using one or more of the motor coils as an inductor), it is important to prevent the motor from turning, or the vehicle might drive off (interrupting the charging process). This can be accomplished by shorting or opening the motor armature coil (depending on the configuration of the motor). Switches to short (or open) the armature are not shown in FIGS. 8A and 8B.

By using these (or similar) circuits, battery recharging can be accomplished from sources of arbitrary voltage without significant extra hardware. Therefore, an infrastructure of charging stations (analogous to contemporary internal-combustion-engine gas stations) need only provide electric current at a few standard voltages (e.g., 96V and 192V, by analogy to “regular” and “premium” gasoline) and each vehicle can convert a standard voltage to a voltage suitable for its battery pack, using its existing motor controller and motor field coils. This paradigm may reduce the cost of deploying charging stations, and allow electric vehicles to recharge without carrying bulky and heavy chargers wherever they go.

It is appreciated that a prior-art motor controller can also be used in a charging configuration if the battery/motor/controller circuit is reconfigured as described above (including disabling the motor), and an emulated throttle signal is provided to the prior-art controller to cause it to switch on and off at an appropriate frequency. Thus, an embodiment of the invention may perform operations including reconfiguring the battery/motor/controller circuit, disabling the motor armature, and emulating a throttle signal. Such an embodiment would also have to monitor the charging current and adjust the emulated throttle signal to achieve desired charging conditions.

In reference to FIG. 4, it was mentioned that an embodiment of the invention may include a programmable processor (e.g., a microcontroller) to generate control signals for an array of semiconductor switches. Although the switching frequency may be, for example, 25 kHz or 30 kHz, contemporary microcontrollers may operate hundreds or thousands of times faster. Therefore, “extra” processing capability is commonly available to PWM controllers implemented according to an embodiment of the invention. Some of this extra processing capability may be used as described below.

First, an embodiment of the invention may monitor the status of individual batteries or cells within the battery pack. Prior-art systems typically monitor only the overall pack voltage and current, but because of manufacturing tolerances and differential wear, each individual battery within the pack may have a slightly different voltage (if the batteries are connected in series, the same current will pass through each). Voltage differences of only a fraction of a volt between batteries can indicate that a battery is weakening or near failure. Monitoring only the total pack voltage may fail to detect these batteries until it is too late. Also, battery voltages are dynamic and change with load, temperature and so on. Thus, a battery whose voltage appears to be within an acceptable range at rest may nevertheless show signs of weakening during use. Continuous monitoring of each battery can provide an early warning of trouble, and a motor controller according to an embodiment of the invention can reduce system load automatically in an attempt to avoid destroying one of the batteries in the pack.

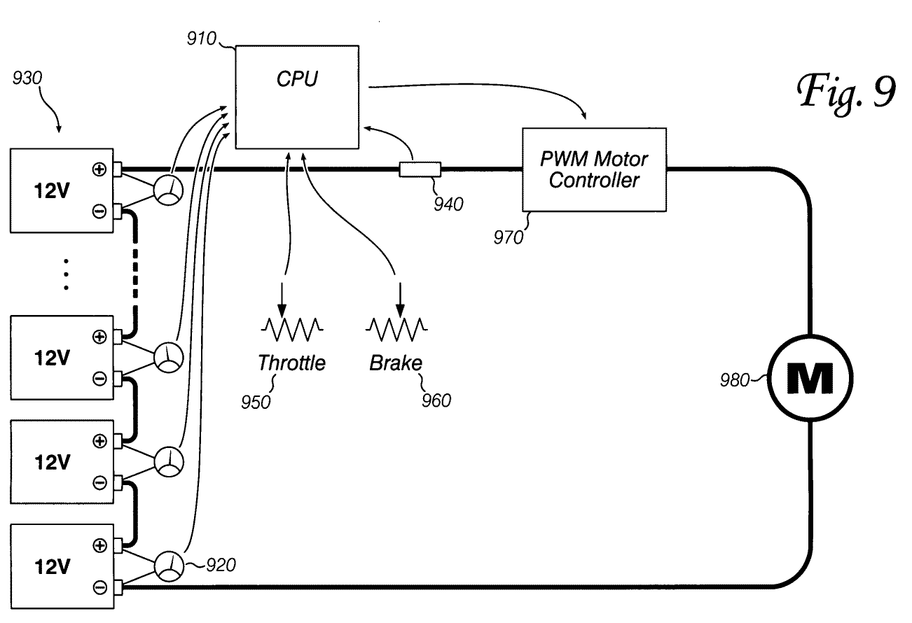

FIG. 9 is a block diagram of a motor control system according to an embodiment of the invention. A programmable processor (“CPU”) 910 monitors conditions and parameters of a number of vehicle subsystems. For example, it may monitor the voltage 920 of each battery in battery pack 930 by making an analog-to-digital converter reading of the voltage between the battery's positive and negative terminals. The CPU may monitor motor current by means of a shunt 940 or a current transformer (not shown). Motor current may also be monitored by another embodiment of the invention discussed below. Driver controls such as throttle 950 and brake 960 are also monitored. (Electric vehicles commonly use a variable resistor as a throttle control input, as shown here. However, the throttle does not directly control current to the motor [i.e., the throttle potentiometer is not placed in series with the motor]. Brake position may also be indicated by a potentiometer, or by a pressure sensor within a hydraulic brake system.)

CPU 910 determines an appropriate motor power setting based on some or all of the inputs and provides a suitable signal to motor controller 970, which in turn controls the current through motor 980. In some embodiments, CPU 910 may be located within motor controller 970, while in other embodiments, it may be located elsewhere in the vehicle. Various sensor querying operations may be delegated to slave processors located around the vehicle, and the collected data may be reported back to a main control processor. Parameters not shown in this Figure may also be monitored and the collected data used to derive a suitable motor power control signal. For example, battery and/or motor temperature may be monitored. In some embodiments, the collected data may be stored in a non-volatile memory for later analysis. A parameter-monitoring CPU can also be added to a prior-art battery/controller/motor system to provide data logging and/or more sophisticated motor control. For example, if such a monitoring CPU noticed that one battery's voltage was falling excessively under load, it could override the throttle signal from the throttle potentiometer to cause the prior-art controller to reduce motor power (thereby reducing the stress on the battery).

Motor current monitoring is traditionally performed by using a shunt: a conductive device of small, known and relatively stable resistance. By measuring the voltage across the shunt, the current through it can be calculated according to Ohm's law. However, shunts are expensive and the signal voltages are small. Another method of monitoring current is to pass the current-carrying conductor through a coil formed of a known number of turns. Current flowing in the main conductor induces a secondary current in the coil. The secondary current is proportional to the main current, so the main current can be calculated after measuring the secondary current.

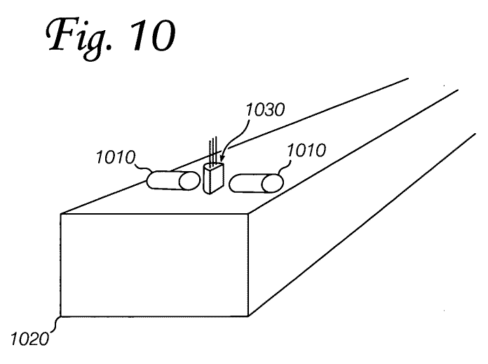

FIG. 10 shows an apparatus for measuring current in a conductor according to an embodiment of the invention. A small slug of material to concentrate a magnetic field is affixed to a conductor within which current is desired to be measured. For example, as shown here, a cylindrical ferrite 1010 may be attached to a buss bar 1020, which may be like those shown in FIGS. 1 and 6. A Hall Effect sensor 1030 is placed near the ferrite. The signal from the sensor is monitored to measure current in the buss bar. The pictured arrangement has been found to yield superior measurements compared to a Hall Effect sensor without a ferrite, or to a Hall Effect sensor inserted in an indentation or hole in the buss bar. If a second sensor is placed on the opposite side of the buss bar, a differential reading can be taken, which largely cancels out the effect of any external magnetic fields and provides a good measurement of current in the buss bar.

Apart from the monitoring and related functions discussed above, an embodiment of the invention can also serve as an adapter between mismatched components that may be brought together in an electric vehicle conversion. For example, as mentioned above, an electric motor controller typically responds to a throttle control that presents a variable resistance to the controller. However, some controllers may treat a zero resistance as “zero” throttle, so motor power increases with resistance; while other controllers may treat a large resistance as “zero” throttle, so motor power increases with decreasing resistance. In addition, although throttle control resistance ranges of 0˜5 kΩ are common, some controllers may respond to different ranges, and/or mechanical limitations may prevent a throttle potentiometer from moving through its complete range. Similar difficulties may affect other user controls also.

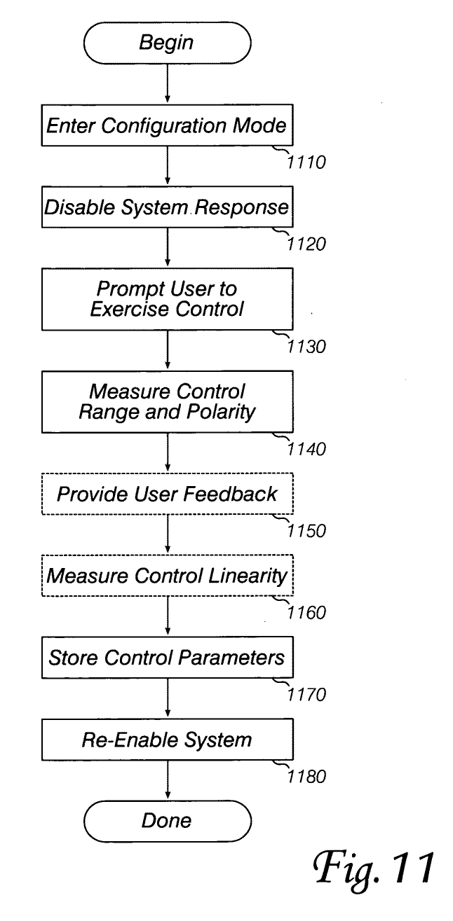

An embodiment of the invention may provide a “configure” mode, in which one or more input controls are moved through their full mechanical ranges, and the resulting detected data used to control a mapping performed by the embodiment from the available sensor data to the input control ranges expected by other parts of the vehicle system. This method is detailed in FIG. 11.

Upon system initialization (e.g., if the system is unconfigured on power-up), or upon activation of a “configure” switch, the system enters configuration mode (1110). System response (such as motor activation) is disabled (1120). This prevents dangerous or erratic operations during the following steps. Now, the user is prompted to exercise a system control (1130). For example, an audible tone may be played, or a message may be displayed on a graphical user interface.

The user operates the control (for example, she may depress the throttle from its “off” position to its limit position) and the system measures the control's range and polarity (1140). In some embodiments, feedback in the form of a tone or a visual meter may be provided (1150), and the control's value at varying positions measured to determine the control's linearity (1160). As a specific example of this operation, a bar graph moving smoothly from zero to full scale may be displayed, prompting the user to depress the throttle a corresponding amount. The measured control value corresponding to the displayed bar graph value is stored so that the system can more accurately determine what functional level a user intends by a particular control position.

The control parameters measured in the previous operations are stored in a memory for subsequent use (1170) and the system is re-enabled to begin normal operations (1180). During normal operations, an embodiment monitors the control device and maps the parameter (i.e., the resistance, voltage or current produced by the control) into a suitable control signal for the motor controller (or other appropriate system). This permits the physical control, which may have imperfections, nonlinearities or mechanically restricted range, to provide a full (and correctly oriented) input signal to the motor controller. The procedure of FIG. 11 may be repeated to configure and calibrate other user input devices as well.

Another function that can be provided through the motor controller software is the recognition of sudden loss of traction or slipping, or the sudden lock-up of the motor. This can be achieved in two ways:

First, without the use of an external speed sensor, programmed algorithms in the controller software constantly compare the values of current and voltage driving the motor and the relative time it takes for those values to change, based on the value of the throttle input. If the current or voltage values change more rapidly than the algorithm has been set to expect, the software will determine that the motor has lost traction or has locked up, and may modify the controller's drive output to bring the values back into the expected range. This may either reduce power to the motor to stop the wheels from spinning, or increase power to cause the motor to resume rotation. In either case, the original rotational direction will be maintained.

Second, if a speed sensor is employed, the controller software can use that input data to measure the acceleration of the motor compared to the positional value from the throttle. If there is a sudden change in speed that falls outside the expected range of operation, the software may again determine the motor has lost traction or locked up, and will modify the controller's drive output to bring the values back into the acceptable range, correcting the condition.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In the preceding description, numerous details were set forth. It will be apparent, however, to one skilled in the art, that the present invention may be practiced without these specific details. In some instances, well-known structures and devices are shown in block diagram form, rather than in detail, to avoid obscuring the present invention.

Some portions of the detailed descriptions were presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, compact disc read-only memory (“CD-ROM”), and magnetic-optical disks, read-only memories (“ROMs”), random access memories (“RAMs”), eraseable, programmable read-only memories (“EPROMs”), electrically-eraseable read-only memories (“EEPROMs”), Flash memories, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals)), etc.

The applications of the present invention have been described largely by reference to specific examples and in terms of particular allocations of functionality to certain hardware and/or software components. However, those of skill in the art will recognize that robust, flexible control of electric motors can also be achieved by software and hardware that distribute the functions of embodiments of this invention differently than herein described. Such variations and implementations are understood to be captured according to the following claims.

The following paragraphs contain concise descriptions of possible embodiments of the invention:

1. An apparatus for controlling delivery of electrical energy to a load, said apparatus comprising:

a plurality of semiconductor switches arranged electrically in parallel;

a plurality of switch drivers, each switch driver to control a subset of the plurality of semiconductor switches and each switch driver disposed near the subset of semiconductor switches controlled by the switch driver; and

a programmable logic device to control the semiconductor switches via signals to the switch drivers.

2. The apparatus of claim 1, further comprising:

a switch interface device to transmit signals from the programmable logic device to the switch drivers;

a first conductor to carry signals from the switch interface to all of the switch drivers; and

a plurality of second conductors, each to carry a signal from the first conductor to a corresponding one of the plurality of switch drivers, wherein

an inductive characteristic of the first conductor conditions the signal so that each of the plurality of second conductors delivers a substantially identical signal to its corresponding one of the plurality of switch drivers.

3. The apparatus of claim 1, further comprising:

a plurality of snubber circuits, each snubber circuit connecting electrically from a terminal of the load to a common terminal of each of the plurality of semiconductor switches.

4. The apparatus of claim 3 wherein each of the plurality of snubber circuits comprises:

a first diode; and

a second diode in series with a capacitor, the first diode and the second diode/capacitor in electrically parallel relation.

5. The apparatus of claim 1, further comprising:

a first buss bar to carry electrical current from a source to a first terminal of each of the plurality of semiconductor switches;

a second buss bar to carry electrical current from a second terminal of each of the plurality of semiconductor switches to the load; and

a third buss bar to carry return current from the load to the source, wherein

at least one of the three buss bars has features to increase its surface area, said at least one of the three buss bars serving as a heat sink for the plurality of semiconductor switches.

6. The apparatus of claim 5 wherein the first buss bar and the second buss bar are separated by a first printed circuit substrate, and

the second buss bar and the third buss bar are separated by a second printed circuit substrate.

7. The apparatus of claim 6 wherein the plurality of switch drivers are disposed on the first printed circuit substrate.
8. The apparatus of claim 5 wherein each semiconductor switch of the plurality of semiconductor switches is attached in thermal contact with the first buss bar.
9. The apparatus of claim 5 wherein each semiconductor switch of the plurality of semiconductor switches is attached in electrical contact with the first buss bar.
10. The apparatus of claim 5 wherein each semiconductor switch of the plurality of semiconductor switches is attached in thermal and electrical contact with the first buss bar.
11. The apparatus of claim 5, further comprising:

a plurality of snubber circuits, each snubber circuit including at least one diode, wherein

each diode of the at least one diode of the plurality of snubber circuits is attached in thermal and electrical contact with the second buss bar.

12. The apparatus of claim 5, further comprising:

a magnetic flux concentrator affixed to one of the first buss bar, the second buss bar, or the third buss bar; and

a sensor positioned near the magnetic flux concentrator, said sensor to produce a signal proportional to an electrical current through the buss bar to which the magnetic flux concentrator is affixed.

13. The apparatus of claim 12 wherein the magnetic flux concentrator is a ferrite and the sensor is a Hall Effect sensor.
14. A system comprising:

a rechargeable battery pack having a first nominal voltage;

an electric motor including an inductive element;

a power controller to regulate delivery of power from the rechargeable battery pack to the electric motor in an operational-mode circuit configuration; and

a charging switch to convert the operational-mode circuit configuration into a charging-mode circuit configuration, wherein

a recharging current from a source having a second nominal voltage flows through the inductive element and a switch of the power controller during a first recharging phase, and

the recharging current flows through the inductive element and a diode of the power controller during a second recharging phase.

15. A system comprising:

a rechargeable battery pack having a first nominal voltage;

an electric motor including an inductive element;

a power controller to regulate delivery of power from the rechargeable battery pack to the electric motor in a first circuit configuration; and

a charging switch to convert the first circuit configuration to a second circuit configuration, wherein

the power controller and the inductive element operate as a boost converter to charge the rechargeable battery pack from a recharging source at a second nominal voltage, said second nominal voltage being less than said first nominal voltage.

16. The system of claim 15 wherein the inductive element is a field coil of a direct-current (“DC”) motor.
17. The system of claim 15, further comprising:

a programmable logic device to measure a parameter concerning the rechargeable battery pack, and

a data interface to transmit the parameter to an analyst.

18. The system of claim 17 wherein the parameter is a voltage of a battery in the rechargeable battery pack.
19. The system of claim 17 wherein the parameter is a temperature of a battery in the rechargeable battery pack.
20. The system of claim 15, further comprising:

a plurality of battery identifiers, each battery identifier to identify a subset of batteries of the rechargeable battery pack.

21. The system of claim 20 wherein a battery identifier is a light-emitting diode (“LED”).
22. A system comprising:

a rechargeable battery pack having a first nominal voltage;

an electric motor including an inductive element;

a power controller to regulate delivery of power from the rechargeable battery pack to the electric motor in a first circuit configuration; and

a charging switch to convert the first circuit configuration to a second circuit configuration, wherein

the power controller and the inductive element operate as a buck converter to charge the rechargeable battery pack from a recharging source at a second nominal voltage, said second nominal voltage being greater than said first nominal voltage.

23. An electric-vehicle recharging adapter comprising:

a circuit-reconfiguration switch to alter a connection of a battery/controller/motor circuit;

a motor disabler to prevent energization of a portion of the motor; and

a throttle emulator to cause the controller to operate as if a throttle was being adjusted, wherein

the altered configuration of the battery/controller/motor circuit functions to charge the battery.

24. The electric-vehicle recharging adapter of claim 23 wherein the controller and an inductive element of the motor operate as a flyback converter to receive electrical current at a first nominal voltage and charge the battery at a second, higher voltage.
25. A power controller for controlling delivery of electrical energy from a source to a load, the power controller comprising:

a switching circuit to modulate electrical conduction between the source and the load in response to a control signal; and

a calibration unit to automatically determine at least one parameter of the control signal.

26. The power controller of claim 25 wherein the control signal is an adjustable resistance and the at least one parameter is a minimum resistance and a maximum resistance.
27. The power controller of claim 25 wherein the control signal is an adjustable voltage and the at least one parameter is a minimum voltage and a maximum voltage.
28. The power controller of claim 25 wherein the control signal is an adjustable current and the at least one parameter is a minimum current and a maximum current.
29. The power controller of claim 25 wherein the control signal is a rotation sensor and the at least one parameter is a direction of rotation.
30. The power controller of claim 25 wherein the control signal is a connection of a multi-pole switch and the at least one parameter is an identification of one of the poles.
31. The power controller of claim 30 wherein the load is a motor, the multi-pole switch selects at least a forward direction and a reverse direction, and the at least one parameter identifies a switch position corresponding to a selection of the forward direction.
32. A method for calibrating a power controller comprising:

receiving a signal to activate a calibration mode;

monitoring a control signal from a control means;

identifying a minimum value of the control signal, a maximum value of the control signal, and a progression of the control signal; and

altering a parameter of the power controller so that a full range of adjustment of the power controller corresponds to a difference between the minimum value of the control signal and the maximum value of the control signal.

33. The method of claim 32 wherein the control signal is a voltage and the parameter is a level of power to be applied to a load.
34. The method of claim 32 wherein the control signal is a current and the parameter is a level of power to be applied to a load.
35. The method of claim 32 wherein the control signal is a resistance and the parameter is a level of power to be applied to a load.
36. The method of claim 32, further comprising:

displaying a linearly-varying target control signal value during the monitoring operation; and

computing a linearity of the control signal based on the target control signal and the monitored control signal.

37. The method of claim 32 wherein the control means is a first control means and the control signal is a first control signal, the method further comprising:

monitoring a second control signal from a second control means;

identifying a minimum value of the second control signal, a maximum value of the second control signal, and a progression of the second control signal; and

altering a parameter of the power controller so that a full range of adjustment of the power controller corresponds to a difference between the minimum value of the second control signal and the maximum value of the second control signal.

38. The method of claim 37 wherein the first control signal is a throttle signal and the second control signal is a brake control signal.
39. A system comprising:

a power controller for controlling delivery of electrical power from a plurality of batteries to a load;

a plurality of battery monitors to monitor subsets of the plurality of batteries; and

a controller adjuster to adjust a parameter of the power controller in response to a signal from one of the plurality of battery monitors.

40. The system of claim 39 wherein the power controller is to perform pulse width modulation (“PWM”) to control delivery of the electrical power.
41. The system of claim 39 wherein the load is an inductive load.
42. The system of claim 41 wherein the inductive load is an electric motor.
43. The system of claim 39 wherein each of the plurality of battery monitors, monitors exactly one of the plurality of batteries.
44. The system of claim 39 wherein each of the battery monitors measures a voltage across the corresponding subset of the plurality of batteries.
45. The system of claim 39 wherein each of the battery monitors measures a current flowing from the corresponding subset of the plurality of batteries.
46. The system of claim 39 wherein each of the battery monitors measures a temperature of the corresponding subset of the plurality of batteries.
47. The system of claim 39 wherein the controller adjuster lowers a maximum current limit in response to the signal from one of the plurality of battery monitors.
48. An apparatus comprising:

a plurality of battery monitors to monitor a characteristic of subsets of batteries in a battery pack; and

a control override to adjust a signal from a motor control to an electrical power controller according to the characteristic of a subset of batteries in the battery pack detected by one of the plurality of battery monitors.

49. The apparatus of claim 48 wherein the characteristic is a voltage of a subset of batteries in the battery pack.
50. The apparatus of claim 48 wherein the characteristic is a temperature of a subset of batteries in the battery pack.
51. The apparatus of claim 48 wherein each subset of batteries in the battery pack contains one battery.
52. The apparatus of claim 48 wherein the control override is to adjust a signal from a throttle.
53. The apparatus of claim 48 wherein the control override is to adjust a signal from a throttle to cause the electrical power controller to reduce a power applied to an electric motor.

We claim:

1. A system comprising:
a rechargeable battery pack having a first nominal voltage;
an electric motor including an inductive element;
a power controller to regulate delivery of power from the rechargeable battery pack to the electric motor in an operational-mode circuit configuration; and
a charging switch to convert the operational-mode circuit configuration into a charging-mode circuit configuration, wherein
a recharging current from a source having a second nominal voltage flows through the inductive element and a switch of the power controller during a first recharging phase, and
the recharging current flows through the inductive element and a diode of the power controller during a second recharging phase.

2. A system comprising:
a rechargeable battery pack having a first nominal voltage;
an electric motor including an inductive element;
a power controller to regulate delivery of power from the rechargeable battery pack to the electric motor in a first circuit configuration; and
a charging switch to convert the first circuit configuration to a second circuit configuration, wherein
the power controller and the inductive element operate as a voltage converter to charge the rechargeable battery pack from a recharging source at a second nominal voltage, said second nominal voltage being different than said first nominal voltage.

3. The system of claim 2 wherein the first nominal voltage is less than the second nominal voltage.

4. The system of claim 2 wherein the first nominal voltage is greater than the second nominal voltage.

5. The system of claim 2 wherein the inductive element is a field winding of a direct-current (“DC”) motor.

6. The system of claim 2 wherein the inductive element is a stator winding of an alternating-current (“AC”) motor.

7. An electric-vehicle recharging adapter comprising:
a circuit-reconfiguration switch to alter a connection of a battery/controller/motor circuit;
a motor disabler to prevent energization of a portion of the motor; and
a controller input emulator to cause the controller to operate as if a driver input device was being adjusted, wherein
the altered configuration of the battery/controller/motor circuit functions to charge the battery.

8. The recharging adapter of claim 7 wherein the controller input emulator is to emulate a vehicle throttle signal.

9. The recharging adapter of claim 7 wherein the controller input emulator is to emulate a vehicle brake signal.

10. The recharging adapter of claim 7 wherein the controller input emulator is to emulate a vehicle transmission control signal.
